(19) United States
(12) Patent Application Publication
(10) Pub. No.: US 2024/0165930 A1
(43) Pub. Date: May 23, 2024

(54) LAMINATED MATERIAL FOR PACKAGING BAG

(71) Applicant: HANGZHOU KENENG NEW MATERIAL TECHNOLOGY CO., LTD., Hangzhou (CN)

(72) Inventor: Guangquan Hu, Hangzhou (CN)

(21) Appl. No.: 18/107,540

(22) Filed: Feb. 9, 2023

(30) Foreign Application Priority Data
Nov. 17, 2022 (CN) 202211441225.1

(51) Int. Cl. B32B 27/08; B32B 3/26; B32B 7/02; B32B 27/32; B32B 27/40; B65D 65/40

(52) U.S. Cl. CPC B32B 27/08; B32B 3/266; B32B 7/02; B32B 27/327; B32B 27/40; B65D 65/40; B32B 2250/05; B32B 2250/24; B32B 2255/10; B32B 2255/205; B32B 2270/00; B32B 2307/54; B32B 2307/5825; B32B 2307/716; B32B 2307/732; B32B 2439/46

(57) ABSTRACT

The present application relates to the technical field of packaging materials for electronic devices, and particularly to a laminated material for a packaging bag. The laminated material for the packaging bag includes a polyurethane outer layer, a polyurethane aluminized composite layer and a PE composite layer from outside to inside successively, the polyurethane aluminized composite layer includes a polyurethane inner layer and a vacuum aluminized film, in which the vacuum aluminized film is attached to the polyurethane outer layer, and both the polyurethane outer layer and the polyurethane inner layer are degradable; and the PE composite layer is formed with a plurality of through holes perforated in the polyurethane inner layer. When the laminated material for the packaging bag is microorganism degradation, both polyurethane outer layer and polyurethane inner layer are degraded, which can help to recycle aluminum.

### CROSS-REFERENCE TO RELATED APPLICATION

The present application claims the priority to China application No. 202211441225.1, filed on Nov. 17, 2022. The entirety of China application No. 202211441225.1 is hereby incorporated by reference herein and made a part of this specification.

### TECHNICAL FIELD

The present application relates to the technical field of packaging materials for electronic devices, and, in particular, to a laminated material for a packaging bag.

### BACKGROUND ART

A plastic packaging bag is a common packaging and accommodating material in daily life. A white pollution problem due to plastic products causes a great influence on environment for a long time. A packaging bag for an electronic device usually contain a metal plating, such as aluminum plating, silver plating, etc. The metal plating has functions of heat insulation, light shielding and external light reflecting, so that the internal electronic device can be protected.

The packaging bags in related technologies are usually formed by coextrusion blow molding of plastic films with different layers, then plated with a metal film and attached with a protection layer. The metal film is usually positioned at a central layer of the packaging bag. Generally, the packaging bag is thrown away directly after use, and the metal plating is thrown away with the packaging bag, which will cause a metal pollution to the environment. Therefore, it is necessary to provide an environmentally friendly packaging bag.

### SUMMARY

In order to solve a problem of metal pollution caused by directly throwing away a packaging bag with aluminum film after use, the present application provides a laminated material for a packaging bag.

The present application provides a laminated material for the packaging bag, adopting the following technical solutions:
a laminated material for the packaging bag includes a polyurethane outer layer, a polyurethane aluminized composite layer and a PE composite layer from outside to inside successively, the polyurethane aluminized composite layer includes a polyurethane inner layer and a vacuum aluminized film, in which the vacuum aluminized film is attached to the polyurethane outer layer, and the polyurethane outer layer and the polyurethane inner layer are degradable; and
a plurality of through holes perforated in the PE composite layer.

In the above technical solutions, both the polyurethane outer layer and the polyurethane inner layer have better oil resistance, abrasion resistance, low temperature resistance, aging resistance, thermal insulation and corrosion resistance, and have a protection effect on packaged electronic devices. The polyurethane aluminized composite layer includes the vacuum aluminized film attached to the polyurethane outer layer. Aluminum has optical characteristics of high reflectivity and strong reflection of a light, so that the polyurethane aluminized composite layer has functions of thermal insulation and reflection. The PE composite layer has an antiseptic effect and a smooth surface, which can prevent the protected electronic products from being polluted and scratched by an outside world during transportation, storage and use, further can protect a bright surface of original electronic products. The laminated material for the packaging bag made of the polyurethane outer layer, the polyurethane inner layer, the polyurethane aluminized composite layer and the PE composite layer has functions of avoiding light, leak proofing, shielding, flame proofing, insulation, protection and other for the electronic products when used to store the electronic products.

The polyurethane aluminized composite layer includes the polyurethane inner layer and the vacuum aluminized film attached to the polyurethane outer layer, a plurality of through holes penetrating to the polyurethane inner layer are formed in the PE composite layer, so that the polyurethane outer layer is degraded when the laminated material for the packaging bag is degraded by microorganisms. Meanwhile, the microorganisms pass through the through holes of the PE composite layer and contact with the polyurethane inner layer, so that a degradation of the polyurethane inner layer can be promoted. At this time, the vacuum aluminized film can be easily separated from the PE composite layer, and the polyurethane outer layer and the polyurethane inner layer are gradually degraded, which can help to recycle aluminum. Moreover, the laminated material for the packaging bag has environmental protection effect, so that an environmental pollution caused by heavy metals such as aluminum can be avoided as far as possible.

In some embodiments, the polyurethane outer layer has a thickness of 10-15 μm, the polyurethane aluminized composite layer has a thickness of 13-17 μm, and the PE composite layer has a thickness of 180-200 μm.

In the above technical solutions, the provided thicknesses of the polyurethane outer layer, polyurethane aluminized composite layer and PE composite layer can ensure a better mechanical strength and thermal insulation property of the laminated material for the packaging bag.

In some embodiments, the PE composite layer includes five layers of PE films named as layer A, layer B, layer C, layer D and layer E, respectively. Thickness percentages of the layer A, the layer B, the layer C, the layer D and the layer E are (13%-17%), (13%-17%), (38%-42%), (13%-17%) and (13%-17%).

In the above technical solutions, the PE composite layer includes five layers of PE films, which ensures the mechanical strength, thermal insulation property and insulating property thereof. The five layers of PE films with different thickness can reduce a light transmittance of the PE composite layer, and further increase a number of light refraction of the PE composite layer and reduce the light transmittance, and thus having protective effects such as avoiding light and insulation for the electronic products stored inside.

In some embodiments, in terms of a weight percentage, each of the five layers of PE films is made from 25-35% low-density polyethylene, 45-55% linear low-density polyethylene and 15-25% metallocene linear low-density polyethylene, based on a total weight of the PE composite layer.

In the above technical solutions, the metallocene linear low-density polyethylene has high mechanical strength and good toughness, but has a high transparency, high cost, and is not soft enough. The low-density polyethylene has a low cost and low light transmittance, but a poor mechanical strength. A performance of the linear low-density polyethylene is between that of the above two. By using three different kinds of polyethylene together, mechanical advantages of different resin plastics can be combined at the same time to obtain a PE film with comprehensive performance.

In some embodiments, the polyurethane inner layer is made from the following raw materials: modified acetate starch, polytetrahydrofuran ether glycol, polyether triol, isophorone diisocyanate, aloe gel, 1,4-butanediol, butanone, triethylamine, deionized water, organic silicon and dibutyltin dilaurate.

In the above technical solutions, —OH of the modified acetate starch is grafted with —NCO of isophorone diisocyanate by polymer group reaction, thereby increasing a chain length of the modified acetate starch. —OH of the polytetrahydrofuran ether glycol and polyether triol are grafted with —NCO of isophorone diisocyanate, meanwhile, residual hydroxyl of the modified acetate starch, polytetrahydrofuran ether glycol and polyether triol initiates a ring-opening polymerization of caprolactone, so that a ternary graft copolymer is formed, and then a cross-linked frame structure is formed, thereby increasing the chain length and branched chains of the modified acetate starch, and ensuring a compatibility, film-forming property and dispersion of products.

The dibutyltin dilaurate is used as a catalyzer to further accelerate reaction rate of the modified acetate starch, and 1,4-butanediol is used as a chain extender to further increase chain length of the modified acetate starch, so that the modified acetate starch has the better film-forming property. The aloe gel is used as a plasticizer, a stabilizer and a binder for degradable materials, so that the modified acetate starch can form a film better, and the prepared polyurethane inner layer has the better tensile strength, degradation property and environmental performance. Therefore, the prepared laminated material for the packaging bag with various specifications are not easy to be broken when being stretched, and have a good flexibility. In addition, the butanone is used as a solvent to greatly reduce a viscosity of a system, and the triethylamine is used as a salt forming agent to neutralize carboxylic acid groups, so that the organic silicon can be emulsified in water, which helps to form an emulsion.

In addition, the aloe gel contains more moisture, which can provide environment humidity required for a microorganism degradation during the microorganism degradation, and accelerate a degradation rate of the polyurethane inner layer. The aloe gel also contains amino acids and compound polysaccharide, which can improve a hydrophilicity and the degradation rate of the polyurethane inner layer. 1,4-butanediol is used as chain extender, which can not only increase the chain length of the modified acetate starch, but also accelerate a decomposition rate of the modified acetate starch during the microorganism degradation, and further can improve the degradation rate of the polyurethane inner layer in cooperation with the aloe gel.

In some embodiments, a preparation method of the modified acetate starch includes the following steps:
S1. preparing oxidized hydroxypropyl starch into saturated starch aqueous solution at 20-30° C.;
S2. adjusting pH of the saturated starch aqueous solution prepared in S1 to 9.5-10 by using a sodium bicarbonate;
S3. dripping an acetic anhydride solution having a mass ratio of acetic anhydride to starch of 12:15-10 into the saturated starch aqueous solution obtained in S2, at a reaction temperature of 70-90° C. for a reaction time of 2-3.5 h, adding lignocellulose, reacting for 1-2 h, cooling, filtering and washing to obtain the modified acetate starch.

In the above technical solutions, the oxidized hydroxypropyl starch is modified by using the acetic anhydride solution, and the prepared starch has a better hydrophobicity and stability. Meanwhile, the prepared modified acetate starch has the better dispersion, so that the modified acetate starch can react with the isophorone diisocyanate better, and a mechanical property, antimicrobial property and degradation property. The lignocellulose is added at the same time, the lignocellulose is an organic flocculent fiber material with a small specific gravity, large specific surface area and excellent stability. The lignocellulose is cooperated with the acetic anhydride solution, which further improves a cohesiveness of the oxidized hydroxypropyl starch, thus the film-forming property and degradation property of the polyurethane inner layer is improved and the environmental pollution is greatly reduced;
in addition, during a subsequent degradation process of the polyurethane inner layer, the modified acetate starch prepared by adding the lignocellulose can decrease a glass transition temperature T_{g} of the polyurethane inner layer, increase a microphase separation degree and promote the degradation of the polyurethane inner layer during degradation process of the polyurethane inner layer.

In some embodiments, a raw material of the polyurethane outer layer is a castor oil-based polyurethane, which is made from castor oil, polytetrahydrofuran ether glycol, isophorone diisocyanate, dibutyltin dilaurate, triethylamine, deionized water and 1,2,3-butanetriol.

In the above technical solution, the castor oil has unique crosslinking characteristics. —OH of the castor oil and the polytetrahydrofuran ether glycol is grafted with —NCO of the isophorone diisocyanate, so that macromolecular polymers with a small amount of branched chains are synthesized. By adding the dibutyltin dilaurate, a grafting rate of the castor oil, polytetrahydrofuran ether glycol and isophorone diisocyanate is accelerated. The 1,2,3-butanetriol is used as the chain extender to further increase a chain length of the castor oil, thus a compatibility and film-forming property of the castor oil-based polyurethane is ensured. The triethylamine is used as the salt forming agent to neutralize the carboxylic acid groups, so that the organic silicon can be emulsified in water, which helps to form the emulsion.

During the microorganism degradation, the polyurethane outer layer can be degraded quickly, however, a degradation rate of the polyurethane outer layer is much less than that of the polyurethane inner layer. The polyurethane inner layer is degraded first, so that the polyurethane aluminized composite layer is separated from the PE composite layer. Then, the polyurethane outer layer is degraded, which helps to recycle vacuum aluminized film. Moreover, the degradation of the polyurethane outer layer and the polyurethane inner layer do not pollute soil, and they can be used as slow-release materials, which can maintain a controlled release ability of a fertilizer in a short time.

In some embodiments, the vacuum aluminized film has a thickness of 380-600 angstrom.

In the above technical solutions, the vacuum aluminized film with thickness of 380-600 angstrom has enough light-proof performance, reflexivity, thermal insulation, and enough thickness for polishing.

In some embodiments, the through hole has a diameter of 0.5-2 mm.

In some embodiments, there are 1-10 through holes per square centimeter of the PE composite layer.

In summary, the present application has the following technical effects:
1. in the present application, the polyurethane outer layer is degraded when the laminated material for the packaging bag is degraded by the microorganisms. Meanwhile, the microorganisms pass through the through holes of the PE composite layer and contact with the polyurethane inner layer, so that the degradation of the polyurethane inner layer can be promoted. At this time, the vacuum aluminized film can be easily separated from the PE composite layer, and the polyurethane outer layer and the polyurethane inner layer are gradually degraded, which can help to recycle the aluminum. Moreover, the laminated material for the packaging bag has environmental protection effect, so that the environmental pollution caused by the heavy metals such as aluminum can be avoided.
2. The polyurethane aluminized composite layer in the present application includes the vacuum aluminized film attached to the polyurethane outer layer, and the aluminum has the optical characteristics of high reflectivity and strong reflection of the light, so that the polyurethane aluminized composite layer has the functions of thermal insulation and reflection. The PE composite layer has the antiseptic effect and the smooth surface, which can prevent the protected electronic products from being polluted and scratched by the outside world during transportation, storage and use process, further can protect the bright surface of original electronic products. The laminated material for the packaging bag made of the polyurethane outer layer, the polyurethane inner layer, the polyurethane aluminized composite layer and the PE composite layer is used to store the electronic products, which has functions of voiding light, leak proofing, shielding, flame proofing, insulation, protection and other effects for the electronic products.
3. the PE composite layer in the present application includes five layers of PE films, which ensures the mechanical strength, thermal insulation property and insulating property thereof. The five layers of PE films with different thickness can reduce the light transmittance of the PE composite layer, and further increase the number of light refraction of the PE composite layer and reduce the light transmittance, and thus having the protective effects such as avoiding light and insulation for the electronic products stored inside.

### DETAILED DESCRIPTION

The present application will be further described in detail below in combination with examples.

Raw materials used in the examples and preparation examples are commercially available products.

### PREPARATION EXAMPLES OF A COMPOSITE LAYER

### Preparation Example 1-1

APE composite layer included five layers of PE films named as layer A, layer B, layer C, layer D and layer E, respectively. The thickness percentages of the layer A, the layer B, the layer C, the layer D and the layer E were 15%, 15%, 40%, 15% and 15%; a thickness of the PE composite layer was 190 μm.

In particular, in terms of a weight percentage, the five layers of PE films were made from kg low-density polyethylene, 50 kg linear low-density polyethylene and 20 kg metallocene linear low-density polyethylene.

Specifically, a preparation method of the five layers of PE films included the following steps:
the low-density polyethylene, linear low-density polyethylene and metallocene linear low-density polyethylene were melted and plasticized at 160° C. for 2 h to form melt I, and melt II, melt III, melt IV and melt V were prepared by the above method; and
melt I, and melt II, melt III, melt IV and melt V were extruded at a speed of 1.2 m/s to form green bodies, and parisons were obtained by fixing the green bodies in a prefabricated mould. The parisons were extruded and blow molded at 1.5 MPa, a blow-up ratio was controlled at 2:1, and an aspect ratio was controlled at 35:1. A cooling and curing operation were performed by using 10° C. cooling water at a flow rate of 30 L/min, then an initial product was obtained. The initial product was drafted by using a screw roller device, a draft ratio was controlled at 2. Then, a winding and packaging operation was performed, so that a coextrusion blown PE composite layer with five layers was obtained.

### Preparation Example 1-2

A difference of preparation example 1-2 from preparation example 1-1 lied in that, the thickness percentages of the layer A, the layer B, the layer C, the layer D and the layer E were 13%, 17%, 42%, 13% and 15%; the thickness of the PE composite layer was 180 μm.

### Preparation Example 1-3

A difference of preparation example 1-3 from preparation example 1-1 lied in that, the thickness percentages of the layer A, the layer B, the layer C, the layer D and the layer E were 17%, 15%, 38%, 17% and 13%; the thickness of the PE composite layer was 200 μm.

### Preparation Example 1-4

A difference of preparation example 1-4 from preparation example 1-1 lied in that, the five layers of PE films were made from 25 kg low-density polyethylene, 45 kg linear low-density polyethylene and 30 kg metallocene linear low-density polyethylene.

### Preparation Example 1-5

A difference of preparation example 1-5 from preparation example 1-1 lied in that, the five layers of PE films were made from 35 kg low-density polyethylene, 55 kg linear low-density polyethylene and 10 kg metallocene linear low-density polyethylene.

### Preparation Example 1-6

A difference of preparation example 1-6 from preparation example 1-1 lied in that, the PE composite layer was made of single layer PE film, and had a thickness of 190 μm.

### PREPARATION EXAMPLES OF THE POLYURETHANE INNER LAYER

### Preparation Example 2-1

By weight, the polyurethane inner layer was made from the following raw materials: 40 kg modified acetate starch, 25 kg polytetrahydrofuran ether glycol, 12 kg polyether triol, 90 kg isophorone diisocyanate, 15 kg aloe gel, 6 kg 1,4-butanediol, 80 kg butanone, 20 kg triethylamine, 100 kg deionized water, 3 kg organic silicon and 2 kg dibutyltin dilaurate.

Specifically, a preparation method of the polyurethane inner layer included the following steps:
the isophorone diisocyanate, polytetrahydrofuran ether glycol, polyether triol and butanone were mixed together, and a temperature was kept at 75° C. for 2 h; then, the temperature was raised to 80° C., and the modified acetate starch, aloe gel, 1,4-butanediol and dibutyltin dilaurate were added, and reacted for 3 h under a condition of keeping temperature then, the temperature was decreased to a room temperature, and the triethylamine was added during high-speed stirring, the deionized water was added to emulsify, the butanone was removed by vacuum distillation, and a degradable polyurethane was obtained; then, the organic silicon was added and mixed evenly for wetting, and a film was formed after coating, so that the polyurethane inner layer was obtained.

In particular, a preparation method of the modified acetate starch included the following steps:
S1. a saturated starch aqueous solution was prepared at 25° C. by using 10 kg oxidized hydroxypropyl starch;
S2. pH of the saturated starch aqueous solution prepared in S1 was adjusted to 9.5-10 by using a sodium bicarbonate solution with 8% mass fraction; and
S3. 10 kg acetic anhydride solution having a mass ratio of acetic anhydride to starch of 12:13 was gradually dripped into the saturated starch aqueous solution obtained in S2, at a reaction temperature of 80° C. for a reaction time of 3 h; then, 15 kg lignocellulose was added, and continued to react for 1.5 h; finally, the modified acetate starch was obtained after cooling, filtering and washing.

### Preparation Example 2-2

A difference of preparation example 2-2 from preparation example 2-1 lied in that, for the raw material of the polyurethane inner layer, the modified acetate starch was replaced with equal amount of acetate starch.

### Preparation Example 2-3

A difference of preparation example 2-3 from preparation example 2-1 lied in that, for the raw material of the polyurethane inner layer, the polytetrahydrofuran ether glycol was replaced with equal amount of modified acetate starch.

### Preparation Example 2-4

A difference of preparation example 2-4 from preparation example 2-1 lied in that, for the raw material of the polyurethane inner layer, the polyether triol was replaced with equal amount of modified acetate starch.

### Preparation Example 2-5

A difference of preparation example 2-5 from preparation example 2-1 lied in that, for the raw material of the polyurethane inner layer, the aloe gel was replaced with equal amount of modified acetate starch.

### Preparation Example 2-6

A difference of preparation example 2-6 from preparation example 2-1 lied in that, for the the preparation method of the modified acetate starch, the lignocellulose was not added.

### Preparation Example 2-7

A difference of preparation example 2-7 from preparation example 2-1 lied in that, the polyurethane inner layer was purchased from Chiyue Century (Guangdong) New Materials Co., Ltd.

### EXAMPLES

### Example 1

A laminated material for a packaging bag included a polyurethane outer layer, a polyurethane aluminized composite layer and a PE composite layer from outside to inside successively. The polyurethane aluminized composite layer included a polyurethane inner layer and a vacuum aluminized film, and a raw material of the polyurethane outer layer was a castor oil-based polyurethane, in which the vacuum aluminized film was attached to the polyurethane outer layer. The castor oil-based polyurethane was made from 30 kg castor oil, 10 kg polytetrahydrofuran ether glycol, 25 kg isophorone diisocyanate, 2 kg dibutyltin dilaurate, 15 kg triethylamine, 80 kg deionized water and 10 kg 1,2,3-butanetriol. Specifically, a preparation method of the castor oil-based polyurethane included the following steps:
the castor oil, polytetrahydrofuran ether glycol, isophorone diisocyanate were mixed together, and the temperature was kept at 80° C. for 3 h; then, the temperature was raised to 90° C., and the dibutyltin dilaurate and 1,2,3-butanetriol were added, and reacted for 2 h under the condition of keeping temperature; then, the temperature was decreased to 50° C., and the triethylamine was added during high-speed stirring, the deionized water was added, and continued stirring for 1 h, so that the castor oil-based polyurethane emulsion was obtained, which was coated to form a film, and then the castor oil-based polyurethane layer was obtained.

The PE composite layer was prepared by preparation example 1-1, and the polyurethane inner layer was prepared by preparation example 2-1.

There were 1-2 through holes with diameter of 0.5 mm per square centimeter of the PE composite layer, which penetrated the polyurethane inner layer.

The polyurethane outer layer had a thickness of 12 μm, the polyurethane aluminized composite layer had a thickness of 15 μm, and the vacuum aluminized film had a thickness of 500 angstrom.

### Example 2

A difference of example 2 from example 1 lied in that, the polyurethane outer layer had a thickness of 10 μm, the polyurethane aluminized composite layer had a thickness of 13 μm, and the vacuum aluminized film had a thickness of 380 angstrom.

### Example 3

A difference of example 3 from example 1 lied in that, the polyurethane outer layer had a thickness of 15 μm, the polyurethane aluminized composite layer had a thickness of 17 μm, and the vacuum aluminized film had a thickness of 600 angstrom.

### Example 4

A difference of example 4 from example 1 lied in that, the PE composite layer was prepared by preparation example 1-2.

### Example 5

A difference of example 5 from example 1 lied in that, the PE composite layer was prepared by preparation example 1-3.

### Example 6

A difference of example 6 from example 1 lied in that, the PE composite layer was prepared by preparation example 1-4.

### Example 7

A difference of example 7 from example 1 lied in that, the PE composite layer was prepared by preparation example 1-5.

### Example 8

A difference of example 8 from example 1 lied in that, the PE composite layer was prepared by preparation example 1-6.

### Example 9

A difference of example 9 from example 1 lied in that, the PE composite layer was prepared by preparation example 2-2.

### Example 10

A difference of example 4 from example 1 lied in that, the PE composite layer was prepared by preparation example 2-3.

### Example 11

A difference of example 11 from example 1 lied in that, the PE composite layer was prepared by preparation example 2-4.

### Example 12

A difference of example 12 from example 1 lied in that, the PE composite layer was prepared by preparation example 2-5.

### Example 13

A difference of example 13 from example 1 lied in that, the PE composite layer was prepared by preparation example 2-6.

### Example 14

A difference of example 14 from example 1 lied in that, the PE composite layer was prepared by preparation example 2-7.

### COMPARATIVE EXAMPLES

### Comparative Example 1

A difference of comparative example 1 from example 1 lied in that, the polyurethane outer layer and the polyurethane inner layer were obtained by processing and reaction of the polybutylene glycol and 4,4′-diphenylmethane diisocyanate by using a spiral foundation equipment and taking the 1,4-butanediol as a chain extender. A soft segment concentration was 44.3%, and a hard segment concentration was 58.6%.

### Comparative Example 2

A difference of comparative example 1 from example 1 lied in that, there was no through hole in the PE composite layer.

Performance Test

The laminated material for the packaging bag prepared in examples 1-14 and comparative examples 1-2 were cut to standard test size, then mechanical properties of films were tested according to ASTM D882-2010, including tensile strength, impact strength and tear strength.

Degradation property test: samples prepared in examples 1-14 and comparative examples 1-2 were placed in a moist soil at 37° C., degradation mass loss rates of the samples after 20d and 45d were tested according to GB/T20197-2006 “Define, classify, marking and degradation property requirement of degradable plastic”.

TABLE 1

| | Mechanical properties | | Degradation property | | |
|---|---|---|---|---|---|
| | Tensile | Tear | Mass loss | Mass loss | Mass loss |
| | strength | strength | rate after | rate after | rate after |
| | (MPa) | (KN/m) | 20 d (%) | 60 d (%) | 90 d (%) |
| Example 1 | 59.3 | 98.5 | 23.5 | 89.1 | 98.5 |
| Example 2 | 59.3 | 98.5 | 23.6 | 89.3 | 98.5 |
| Example 3 | 59.2 | 98.4 | 23.4 | 88.9 | 98.4 |
| Example 4 | 59.1 | 98.3 | 23.5 | 89.1 | 98.5 |
| Example 5 | 59.0 | 98.3 | 23.5 | 89.1 | 98.5 |
| Example 6 | 59.1 | 98.2 | 23.5 | 89.1 | 98.5 |
| Example 7 | 59.0 | 98.3 | 23.5 | 89.1 | 98.5 |
| Example 8 | 48.6 | 87.9 | 23.5 | 89.1 | 98.5 |
| Example 9 | 52.8 | 89.1 | 18.0 | 84.5 | 93.1 |
| Example 10 | 57.9 | 96.0 | 20.2 | 86.7 | 95.3 |
| Example 11 | 57.8 | 96.9 | 20.3 | 86.8 | 95.2 |
| Example 12 | 53.1 | 90.2 | 19.9 | 85.3 | 94.6 |
| Example 13 | 53.3 | 90.5 | 20.0 | 85.4 | 94.8 |
| Example 14 | 55.1 | 95.2 | 21.8 | 86.9 | 94.0 |
| Comparative | 50.2 | 87.4 | \ | \ | \ |
| example 1 | | | | | |
| Comparative | 59.4 | 98.6 | 13.3 | 70.1 | 78.4 |
| example 2 | | | | | |

It can be seen from table 1 that, the laminated material for the packaging bag prepared in the examples 1-3 had a better mechanical property and degradation property. In particular, the laminated material for the packaging bag prepared in example 1 had the tensile strength of 59.3 MPa, the tear strength of 98.5 KN/m, the mass loss rate after 20d of 23.5%, the mass loss rate after 60d of 89.1% and the mass loss rate after 90d of 98.5%.

In examples 4-5, the thickness of the PE composite layer was changed and the thickness percentages of the layer A, the layer B, the layer C, the layer D and the layer E were adjusted, the mechanical property of the laminated material for the packaging bag was slightly decreased, but the degradation property remained unchanged. In examples 6-7, contents of the low-density polyethylene, linear low-density polyethylene and metallocene linear low-density polyethylene were changed, the mechanical property of prepared laminated material for the packaging bag was slightly decreased, but the degradation property remained unchanged.

The PE composite layer prepared in example 8 was made of single layer PE film. It can be seen from table 1 that, the tensile strength of the prepared laminated material for the packaging bag was 48.6 MPa, the tear strength was 87.9 KN/m. The PE composite layer with five layers in example 1 was composed of the layer A, the layer B, the layer C, the layer D and the layer E according to a certain thickness percentage. Comparing example 8 with example 1, it can be seen that the PE composite layer with five layers composed of the layer A, the layer B, the layer C, the layer D and the layer E had better tensile strength and tear strength, but degradation property of example 8 was the same as that of example 1. In example 9, the modified acetate starch was replaced with equal amount of acetate starch, it can be seen from table 1 that, the mechanical property of the laminated material for the packaging bag was obviously decreased, and the degradation property was also decreased, which indicated that the modified acetate starch prepared in the present application had better degradation property, and a film-forming property and the degradation property of the polyurethane inner layer was improved, and an environment pollution was greatly reduced.

In examples 10-11, the polytetrahydrofuran ether glycol or the polyether triol was replaced with equal amount of the modified acetate starch. It can be seen from table 1 that, the mechanical property of the laminated material for the packaging bag was obviously decreased, and the degradation property was also decreased, which indicated that —OH of the polytetrahydrofuran ether glycol and polyether triol was grafted with —NCO of the isophorone diisocyanate, meanwhile, residual hydroxyl of the modified acetate starch, the polytetrahydrofuran ether glycol and the polyether triol initiated a ring-opening polymerization of caprolactone, so that a ternary graft copolymer was formed, and then a cross-linked frame structure was formed, thus a compatibility, film-forming property and dispersion of products were ensured.

In example 12, the aloe gel was replaced with equal amount of the modified acetate starch. It can be seen from table 1 that, the mechanical property of the laminated material for the packaging bag was obviously decreased, and the degradation property was also decreased, which indicated that the aloe gel used in the present application provided environment humidity required for a microorganism degradation during the microorganism degradation, and accelerated a degradation rate of the polyurethane inner layer. The aloe gel was used as a plasticizer, a stabilizer and a binder for degradable materials, so that the modified acetate starch formed the film better, and the prepared polyurethane inner layer had the better tensile strength, degradation property and environmental performance.

In example 13, the polyether triol was replaced with equal amount of the modified acetate starch. It can be seen from table 1 that, the mechanical property of the laminated material for the packaging bag was obviously decreased, and the degradation property was also decreased, which indicated that during a subsequent degradation process of the polyurethane inner layer, the lignocellulose used in the present application decreased a glass transition temperature T_{g} of the polyurethane inner layer, increased a microphase separation degree, and promoted the degradation of the polyurethane inner layer. Moreover, the lignocellulose was an organic flocculent fiber material with excellent stability. The lignocellulose was cooperated with the acetic anhydride solution, which further improved a cohesiveness of the oxidized hydroxypropyl starch, thus the mechanical property of the polyurethane inner layer was improved.

In example 14, the polyurethane inner layer was commercially available product. It can be seen from table 1 that, the mechanical property of the laminated material for the packaging bag was obviously decreased, and the degradation property was also decreased, which indicated that, the polyurethane inner layer and the castor oil-based polyurethane layer prepared in the present application had better mechanical property and degradation rate.

The polyurethane outer layer and the polyurethane inner layer in comparative example 1 were made from non-degradable raw materials. It can be seen from table 1 that, the mechanical property of the laminated material for the packaging bag was obviously decreased, however, because the polyurethane outer layer and polyurethane inner layer cannot be degraded, the vacuum aluminized film cannot be recycled.

There was no through hole in the PE composite layer in example 2. It can be seen from table 1 that, the mechanical property of the laminated material for the packaging bag was slightly better than that in example 1, but the degradation property was obviously decreased. Because there was no through hole in the PE composite layer, microorganisms cannot pass through the PE composite layer to the polyurethane inner layer. Therefore, the polyurethane inner layer cannot be degraded, and only the polyurethane outer layer can be degraded, so that the vacuum aluminized film cannot be recycled.

The above are the preferred embodiments of the present application, which are not intended to limit the protection scope of the present application. Therefore, all equivalent changes made according to the structure, shape and principle of the present application should be covered within the protection scope of the present application.

What is claimed is:

1. A laminated material for a packaging bag, comprising a polyurethane outer layer, a polyurethane aluminized composite layer and a polyethylene (PE) composite layer, wherein the polyurethane aluminized composite layer comprises a polyurethane inner layer and a vacuum aluminized film, the vacuum aluminized film is attached to the polyurethane outer layer, and both the polyurethane outer layer and the polyurethane inner layer are degradable; and,
a plurality of through holes are perforated in the PE composite layer.

2. The laminated material for the packaging bag according to claim 1, wherein the polyurethane outer layer has a thickness of 10-15 μm, the polyurethane aluminized composite layer has a thickness of 13-17 μm, and the PE composite layer has a thickness of 180-200 μm.

3. The laminated material for the packaging bag according to claim 1, wherein the PE composite layer comprises five layers of PE films named as layer A, layer B, layer C, layer D and layer E, respectively; and thickness percentages of the layer A, the layer B, the layer C, the layer D and the layer E are (13%-17%), (13%-17%), (38%-42%), (13%-17%) and (13%-17%).

4. The laminated material for the packaging bag according to claim 3, wherein each of the five layers of PE films is made from 25-35% low-density polyethylene, 45-55% linear low-density polyethylene and 15-25% metallocene linear low-density polyethylene, based on a total weight of the PE composite layer.

5. The laminated material for the packaging bag according to claim 1, wherein the polyurethane inner layer is made from modified acetate starch, polytetrahydrofuran ether glycol, polyether triol, isophorone diisocyanate, aloe gel, 1,4-butanediol, butanone, triethylamine, deionized water, organic silicon and dibutyltin dilaurate.

6. The laminated material for the packaging bag according to claim 5, wherein a preparation method of the modified acetate starch comprises the following steps:
S1. preparing oxidized hydroxypropyl starch into a saturated starch aqueous solution at 20-30° C.;
S2. adjusting pH of the saturated starch aqueous solution prepared in S1 to 9.5-10; and
S3. dripping an acetic anhydride solution having a mass ratio of acetic anhydride to starch of 12:15-10 into the saturated starch aqueous solution obtained in S2 at a reaction temperature of 70-90° C. for a reaction time of 2-3.5 hours, adding lignocellulose, reacting for another 1-2 hours, cooling, filtering, and washing to obtain the modified acetate starch.

7. The laminated material for the packaging bag according to claim 1, wherein a raw material of the polyurethane outer layer is a castor oil-based polyurethane made from castor oil, polytetrahydrofuran ether glycol, isophorone diisocyanate, dibutyltin dilaurate, triethylamine, deionized water and 1,2,3-butanetriol.

8. The laminated material for the packaging bag according to claim 1, wherein the vacuum aluminized film has a thickness of 380-600 angstrom.

9. The laminated material for the packaging bag according to claim 1, wherein each of the plurality of through holes has a diameter of 0.5-2 mm.

10. The laminated material for the packaging bag according to claim 1, wherein there are 1-10 through holes of the plurality of through holes per square centimeter of the PE composite layer.
